(19) United States
(12) Patent Application Publication
(10) Pub. No.: US 2017/0083313 A1
(43) Pub. Date: Mar. 23, 2017

(54) CONFIGURING COARSE-GRAINED RECONFIGURABLE ARRAYS (CGRAs) FOR DATAFLOW INSTRUCTION BLOCK EXECUTION IN BLOCK-BASED DATAFLOW INSTRUCTION SET ARCHITECTURES (ISAs)

(71) Applicant: QUALCOMM Incorporated, San Diego, CA (US)

(72) Inventors: Karthikeyan Sankaralingam, Madison, WI (US); Gregory Michael Wright, Chapel Hill, NC (US)

(21) Appl. No.: 14/861,201

(22) Filed: Sep. 22, 2015

(51) Int. Cl. G06F 9/30; G06F 15/78

(52) U.S. Cl. CPC G06F 9/3005; G06F 9/3016; G06F 15/7867

(57) ABSTRACT

Configuring coarse-grained reconfigurable arrays (CGRAs) for dataflow instruction block execution in block-based dataflow instruction set architectures (ISAs) is disclosed. In one aspect, a CGRA configuration circuit is provided, comprising a CGRA having an array of tiles, each of which provides a functional unit and a switch. An instruction decoding circuit of the CGRA configuration circuit maps a dataflow instruction within a dataflow instruction block to one of the tiles of the CGRA. The instruction decoding circuit decodes the dataflow instruction, and generates a function control configuration for the functional unit of the mapped tile to provide the functionality of the dataflow instruction. The instruction decoding circuit further generates switch control configurations for switches along a path of tiles within the CGRA so that an output of the functional unit of the mapped tile is routed to each tile corresponding to consumer instructions of the dataflow instruction.

### BACKGROUND

I. Field of the Disclosure

The technology of the disclosure relates generally to execution of dataflow instruction blocks in computer processor cores based on block-based dataflow instruction set architectures (ISAs).

II. Background

Modern computer processors are made up of functional units that perform operations and calculations, such as addition, subtraction, multiplication, and/or logical operations, for executing computer programs. In a conventional computer processor, data paths connecting these functional units are defined by physical circuits, and thus are fixed. This enables the computer processor to provide high performance at the cost of reduced hardware flexibility.

One option for combining the high performance of conventional computer processors with the ability to modify dataflow between functional units is a coarse-grained reconfigurable array (CGRA). A CGRA is a computer processing structure consisting of an array of functional units that are interconnected by a configurable, scalable network (such as a mesh, as a non-limiting example). Each functional unit within the CGRA is directly connected to its neighboring units, and is capable of being configured to execute conventional word-level operations such as addition, subtraction, multiplication, and/or logical operations. By appropriately configuring each functional unit and the network that interconnects them, operand values may be generated by “producer” functional units and routed to “consumer” functional units. In this manner, a CGRA may be dynamically configured to reproduce the functionality of different types of compound functional units without requiring operations such as per-instruction fetching, decoding, register reading and renaming, and scheduling. Accordingly, CGRAs may represent an attractive option for providing high processing performance while reducing power consumption and chip area.

However, widespread adoption of CGRAs has been hampered by a lack of architectural support for abstracting and exposing CGRA configuration to compilers and programmers. In particular, conventional block-based dataflow instruction set architectures (ISAs) lack the syntactic and semantic capabilities to enable programs to detect the existence and configuration of a CGRA. As a consequence, a program that has been compiled to use a CGRA for processing is unable to execute on a computer processor that does not provide a CGRA. Moreover, even if a CGRA is provided by the computer processor, the resources of the CGRA must match exactly the configuration expected by the program for the program to be able to execute successfully.

### SUMMARY OF THE DISCLOSURE

Aspects disclosed in the detailed description include configuring coarse-grained reconfigurable arrays (CGRAs) for dataflow instruction block execution in block-based dataflow instruction set architectures (ISAs). In one aspect, a CGRA configuration circuit is provided in a block-based dataflow ISA. The CGRA configuration circuit is configured to dynamically configure a CGRA to provide the functionality of a dataflow instruction block. The CGRA comprises an array of tiles, each of which provides a functional unit and a switch. An instruction decoding circuit of the CGRA configuration circuit maps each dataflow instruction within the dataflow instruction block to one of the tiles of the CGRA. The instruction decoding circuit then decodes each dataflow instruction, and generates a function control configuration for the functional unit of the tile corresponding to the dataflow instruction. The function control configuration may be used to configure the functional unit to provide the functionality of the dataflow instruction. The instruction decoding circuit further generates a switch control configuration of the switch of each of one or more path tiles of the CGRA to route an output of the functional unit of the mapped tile to a destination tile of the CGRA corresponding to each consumer instruction of the dataflow instruction (i.e., other dataflow instructions within the dataflow instruction block that take an output of the dataflow instruction as input). In some aspects, before generating the switch control configuration, the instruction decoding circuit may determine destination tiles of the CGRA corresponding to each consumer instruction of the dataflow instruction. Path tiles that represent a path within the CGRA from the tile mapped to the dataflow instruction to each destination tile may then be determined. In this manner, the CGRA configuration circuit dynamically generates a configuration for the CGRA that reproduces the functionality of the dataflow instruction block, thus enabling the block-based dataflow ISA to exploit the processing functionality of the CGRA efficiently and transparently.

In another aspect, a CGRA configuration circuit of a block-based dataflow ISA is disclosed. The CGRA configuration circuit comprises a CGRA comprising a plurality of tiles, each tile of the plurality of tiles comprising a functional unit and a switch. The CGRA configuration circuit further comprises an instruction decoding circuit. The instruction decoding circuit is configured to receive, from a block-based dataflow computer processor core, a dataflow instruction block comprising a plurality of dataflow instructions. The instruction decoding circuit is further configured to, for each dataflow instruction of the plurality of dataflow instructions, map the dataflow instruction to a tile of the plurality of tiles of the CGRA, and decode the dataflow instruction. The instruction decoding circuit is also configured to generate a function control configuration of the functional unit of the mapped tile to correspond to a functionality of the dataflow instruction. The instruction decoding circuit is additionally configured to, for each consumer instruction of the dataflow instruction, generate a switch control configuration of the switch of each of one or more path tiles of the plurality of tiles of the CGRA to route an output of the functional unit of the mapped tile to a destination tile of the plurality of tiles of the CGRA corresponding to the consumer instruction.

In another aspect, a method for configuring a CGRA for dataflow instruction block execution in a block-based dataflow ISA is provided. The method comprises receiving, by an instruction decoding circuit from a block-based dataflow computer processor core, a dataflow instruction block comprising a plurality of dataflow instructions. The method further comprises, for each dataflow instruction of the plurality of dataflow instructions, mapping the dataflow instruction to a tile of a plurality of tiles of a CGRA, each tile of the plurality of tiles comprising a functional unit and a switch. The method also comprises decoding the dataflow instruction, and generating a function control configuration of the functional unit of the mapped tile to correspond to a functionality of the dataflow instruction. The method additionally comprises, for each consumer instruction of the dataflow instruction, generating a switch control configuration of the switch of each of one or more path tiles of the plurality of tiles of the CGRA to route an output of the functional unit of the mapped tile to a destination tile of the plurality of tiles of the CGRA corresponding to the consumer instruction.

In another aspect, a CGRA configuration circuit of a block-based dataflow ISA for configuring a CGRA comprising a plurality of tiles, each tile of the plurality of tiles comprising a functional unit and a switch, is provided. The CGRA configuration circuit comprises a means for receiving, from a block-based dataflow computer processor core, a dataflow instruction block comprising a plurality of dataflow instructions. The CGRA configuration circuit further comprises, for each dataflow instruction of the plurality of dataflow instructions, a means for mapping the dataflow instruction to a tile of a plurality of tiles of a CGRA, and a means for decoding the dataflow instruction. The CGRA configuration circuit also comprises a means for generating a function control configuration of the functional unit of the mapped tile to correspond to a functionality of the dataflow instruction. The CGRA configuration circuit additionally comprises, for each consumer instruction of the dataflow instruction, a means for generating a switch control configuration of the switch of each of one or more path tiles of the plurality of tiles of the CGRA to route an output of the functional unit of the mapped tile to a destination tile of the plurality of tiles of the CGRA corresponding to the consumer instruction.

### BRIEF DESCRIPTION OF THE FIGURES

FIG. 1 is a block diagram of an exemplary block-based dataflow computer processor core based on a block-based dataflow instruction set architecture (ISA) with which a coarse-grained reconfigurable array (CGRA) configuration circuit may be used;

FIG. 2 is a block diagram of exemplary elements of a CGRA configuration circuit configured to configure a CGRA for dataflow instruction block execution;

FIG. 3 is a diagram illustrating an exemplary dataflow instruction block comprising a sequence of dataflow instructions to be processed by the CGRA configuration circuit of FIG. 2;

FIGS. 4A-4C are block diagrams illustrating exemplary elements and communications flows within the CGRA configuration circuit of FIG. 2 for generating a configuration for the CGRA of FIG. 2 to provide the functionality of the dataflow instructions of FIG. 3;

FIGS. 5A-5D are flowcharts illustrating exemplary operations of the CGRA configuration circuit of FIG. 2 for configuring the CGRA for dataflow instruction block execution; and

FIG. 6 is a block diagram of an exemplary computing device that may include the block-based dataflow computer processor core of FIG. 1 that employs the CGRA configuration circuit of FIG. 2.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include configuring coarse-grained reconfigurable arrays (CGRAs) for dataflow instruction block execution in block-based dataflow instruction set architectures (ISAs). In one aspect, a CGRA configuration circuit is provided in a block-based dataflow ISA. The CGRA configuration circuit is configured to dynamically configure a CGRA to provide the functionality of a dataflow instruction block. The CGRA comprises an array of tiles, each of which provides a functional unit and a switch. An instruction decoding circuit of the CGRA configuration circuit maps each dataflow instruction within the dataflow instruction block to one of the tiles of the CGRA. The instruction decoding circuit then decodes each dataflow instruction, and generates a function control configuration for the functional unit of the tile corresponding to the dataflow instruction. The function control configuration may be used to configure the functional unit to provide the functionality of the dataflow instruction. The instruction decoding circuit further generates a switch control configuration of the switch of each of one or more path tiles of the CGRA to route an output of the functional unit of the mapped tile to a destination tile of the CGRA corresponding to each consumer instruction of the dataflow instruction (i.e., other dataflow instructions within the dataflow instruction block that take an output of the dataflow instruction as input). In some aspects, before generating the switch control configuration, the instruction decoding circuit may determine destination tiles of the CGRA corresponding to each consumer instruction of the dataflow instruction. Path tiles that represent a path within the CGRA from the tile mapped to the dataflow instruction to each destination tile may then be determined. In this manner, the CGRA configuration circuit dynamically generates a configuration for the CGRA that reproduces the functionality of the dataflow instruction block, thus enabling the block-based dataflow ISA to exploit the processing functionality of the CGRA efficiently and transparently.

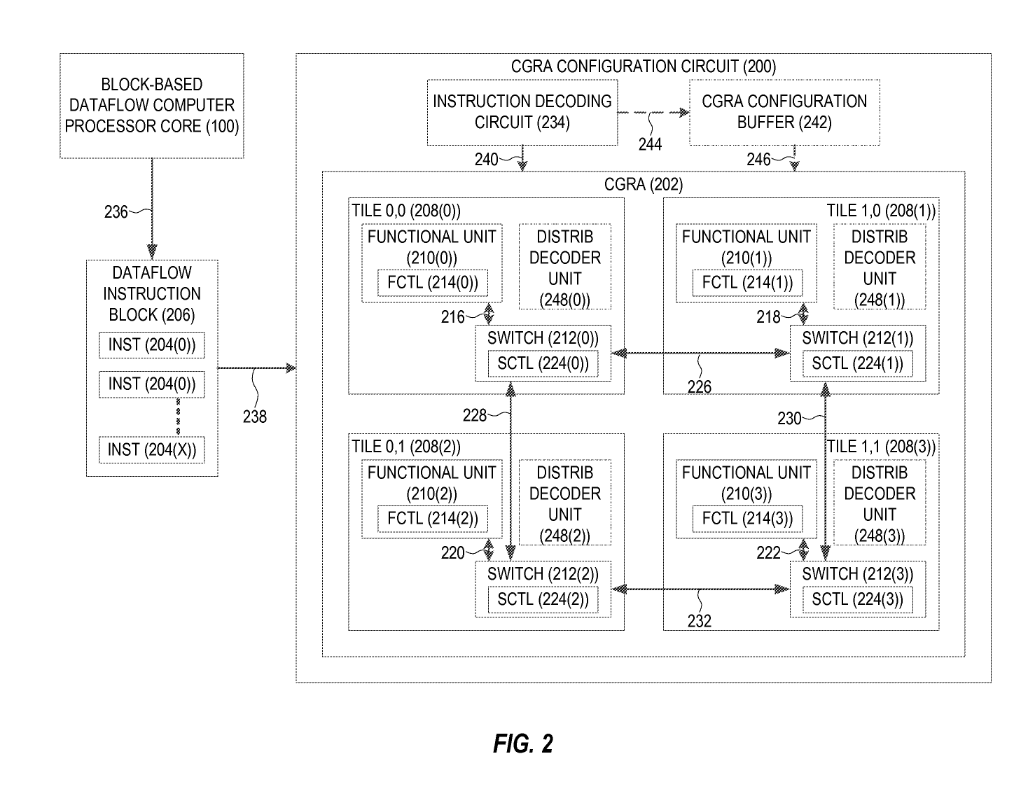

Before exemplary elements and operations of a CGRA configuration circuit are discussed, an exemplary block-based dataflow computer processor core based on a block-based dataflow ISA (e.g., the E2 microarchitecture, as a non-limiting example) is described. As discussed in greater detail below with respect to FIG. 2, the CGRA configuration circuit may be used to enable the exemplary block-based dataflow computer processor core to achieve greater processor performance using a CGRA.

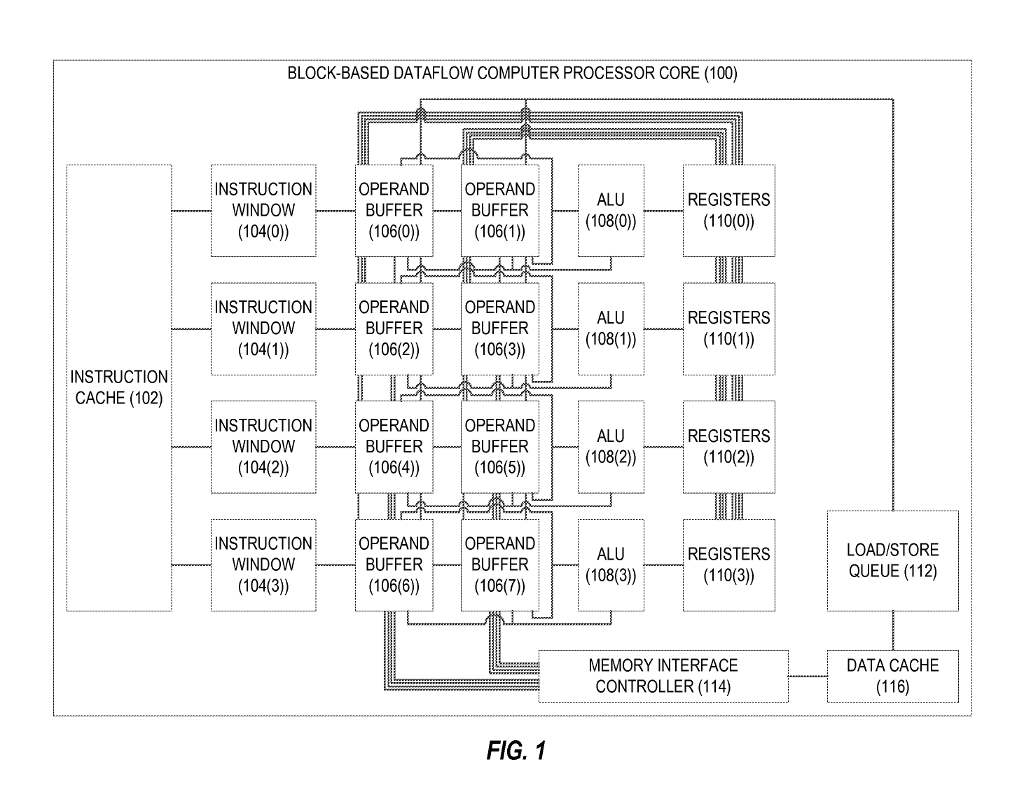

In this regard, FIG. 1 is a block diagram of a block-based dataflow computer processor core 100 that may operate in conjunction with a CGRA configuration circuit discussed in greater detail below. The block-based dataflow computer processor core 100 may encompass any one of known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor dies or packages. While FIG. 1 illustrates a single block-based dataflow computer processor core 100, it is to be understood that many conventional block-based dataflow computer processors (not shown) provide multiple, communicatively coupled block-based dataflow computer processor cores 100. As a non-limiting example, some aspects may provide a block-based dataflow computer processor comprising thirty-two (32) block-based dataflow computer processor cores 100.

As noted above, the block-based dataflow computer processor core 100 is based on a block-based dataflow ISA. As used herein, a “block-based dataflow ISA” is an ISA in which a computer program is divided into dataflow instruction blocks, each of which comprises multiple dataflow instructions that are executed atomically. Each dataflow instruction explicitly encodes information regarding producer/consumer relationships between itself and other dataflow instructions within the dataflow instruction block. The dataflow instructions are executed in an order determined by the availability of input operands (i.e., a dataflow instruction is allowed to execute as soon as all of its input operands are available, regardless of the program order of the dataflow instruction). All register writes and store operations within the dataflow instruction block are buffered until execution of the dataflow instruction block is complete, at which time the register writes and store operations are committed together.

In the example of FIG. 1, the block-based dataflow computer processor core 100 includes an instruction cache 102 that provides dataflow instructions (not shown) for processing. In some aspects, the instruction cache 102 may comprise an onboard Level 1 (L1) cache. The block-based dataflow computer processor core 100 further includes four (4) processing “lanes,” each comprising one instruction window 104(0)-104(3), two operand buffers 106(0)-106(7), one arithmetic logic unit (ALU) 108(0)-108(3), and one set of registers 110(0)-110(3). A load/store queue 112 is provided for queuing store instructions, and a memory interface controller 114 controls dataflow to and from the operand buffers 106(0)-106(7), the registers 110(0)-110(3), and a data cache 116. Some aspects may provide that the data cache 116 comprises an onboard L1 cache.

In exemplary operation, a dataflow instruction block (not shown) is fetched from the instruction cache 102, and the dataflow instructions (not shown) therein are loaded into one or more of the instruction windows 104(0)-104(3). In some aspects, the dataflow instruction block may have a variable size of between four (4) and 128 dataflow instructions. Each of the instruction windows 104(0)-104(3) forwards an opcode (not shown) corresponding to each dataflow instruction, along with any operands (not shown) and instruction target fields (not shown), to the associated ALUs 108(0)-108(3), the associated registers 110(0)-110(3), or the load/store queue 112, as appropriate. Any results (not shown) from executing each dataflow instruction are then sent to one of the operand buffers 106(0)-106(7) or registers 110(0)-110(3) based on the instruction target fields of the dataflow instruction. Additional dataflow instructions may be queued for execution as results from previous dataflow operations are stored in the operand buffers 106(0)-106(7). In this manner, the block-based dataflow computer processor core 100 may provide high-performance out-of-order (OOO) execution of dataflow instruction blocks.

Programs compiled to employ a CGRA may be able to achieve further performance enhancements when executed by the block-based dataflow computer processor core 100 of FIG. 1 in conjunction with a CGRA. However, as discussed above, the block-based dataflow ISA on which the block-based dataflow computer processor core 100 is based may not provide architectural support for enabling programs to detect the existence and configuration of a CGRA. Consequently, if a CGRA is not provided, a program that has been compiled to use a CGRA for processing will be unable to execute on the block-based dataflow computer processor core 100. Moreover, even if a CGRA were provided by the block-based dataflow computer processor core 100 of FIG. 1, the resources of the CGRA would have to match exactly the configuration expected by the program for the program to be able to execute successfully.

In this regard, FIG. 2 illustrates a CGRA configuration circuit 200 that is provided alongside the block-based dataflow computer processor core 100. The CGRA configuration circuit 200 is configured to dynamically configure a CGRA 202 for dataflow instruction block execution. In particular, rather than requiring a program to be specifically compiled to use the CGRA 202, the CGRA configuration circuit 200 instead is configured to analyze multiple dataflow instructions 204(0)-204(X) of a dataflow instruction block 206, and generate a CGRA configuration (not shown) for the CGRA 202 to provide functionality for executing the dataflow instructions 204(0)-204(X) the dataflow instruction block 206. Assuming that a compiler that generated the dataflow instruction block 206 encoded all data regarding the producer/consumer relationships between the dataflow instructions 204(0)-204(X), the CGRA configuration circuit 200 is able to dynamically generate the CGRA configuration based on the data within the dataflow instruction block 206.

As seen in FIG. 2, the CGRA 202 of the CGRA configuration circuit 200 is made up of four (4) tiles 208(0)-208(3) that provide corresponding functional units 210(0)-210(3) and switches 212(0)-212(3). It is to be understood that the CGRA 202 is shown as having four (4) tiles 208(0)-208(3) for illustrative purposes only, and that in some aspects the CGRA 202 may include more tiles 208 than illustrated herein. For example, the CGRA 202 may include a same or greater number of tiles 208 as the number of dataflow instructions 204(0)-204(X) within the dataflow instruction block 206. In some aspects, the tiles 208(0)-208(3) may be referred to using a coordinate system referring to the column and row of each of the tiles 208(0)-208(3) within the CGRA 202. Thus, for example, the tile 208(0) may also be referred to as “tile 0,0,” indicating that it is positioned at column 0, row 0 within the CGRA 202. Similarly, the tiles 208(1), 208(2), and 208(3) may be referred to as “tile 1,0,” “tile 0,1,” and “tile 1,1,” respectively.

Each functional unit 210(0)-210(3) of the tiles 208(0)-208(3) of the CGRA 202 contains logic for implementing a number of conventional word-level operations such as addition, subtraction, multiplication, and/or logical operations, as non-limiting examples. Each functional unit 210(0)-210(3) may be configured using a corresponding function control configuration (FCTL) 214(0)-214(3) to perform one of the supported operations at a time. For example, the functional unit 210(0) first may be configured to operate as a hardware adder by the FCTL 214(0). The FCTL 214(0) later may be modified to configure the functional unit 210(0) to operate as a hardware multiplier for a subsequent operation. In this manner, the functional units 210(0)-210(3) may be reconfigured to perform different operations as specified by the FCTLs 214(0)-214(3).

The switches 212(0)-212(3) of the tiles 208(0)-208(3) are connected to their associated functional units 210(0)-210(3), as indicated by bidirectional arrows 216, 218, 220, and 222. In some aspects, each of the switches 212(0)-212(3) may be connected to the corresponding functional units 210(0)-210(3) via a local port (not shown). The switches 212(0)-212(3) may also be configured using corresponding switch control configurations (SCTLs) 224(0)-224(3) to connect to all neighboring switches 212(0)-212(3). Thus, in the example of FIG. 2, the switch 212(0) is connected to the switch 212(1), as indicated by bidirectional arrow 226, and is also connected to the switch 212(2), as indicated by bidirectional arrow 228. The switch 212(1) is further connected to the switch 212(3), as indicated by bidirectional arrow 230, while the switch 212(2) is also connected to the switch 212(3), as indicated by bidirectional arrow 232.

In some aspects, the switches 212(0)-212(3) may be connected via ports (not shown) referred to as north, east, south, and west ports. Accordingly, the switch control configurations 224(0)-224(3) may specify on which ports the corresponding switches 212(0)-212(3) receive input from and/or send output to other switches 212(0)-212(3). As a non-limiting example, the switch control configuration 224(1) may specify that the switch 212(1) will receive input for the functional unit 210(1) from the switch 212(0) via its west port, and may provide output from the functional unit 210(1) to the switch 212(3) via its south port. It is to be understood that the switches 212(0)-212(3) may provide more or fewer ports than illustrated in the example of FIG. 2 to enable any desired level of interconnectedness between the switches 212(0)-212(3).

The CGRA configuration generated by the CGRA configuration circuit 200 to configure the CGRA 202 to provide the functionality of the dataflow instruction block 206 includes the function control configurations 214(0)-214(3) and the switch control configurations 224(0)-224(3) of the tiles 208(0)-208(3) of the CGRA 202. To generate the function control configurations 214(0)-214(3) and the switch control configurations 224(0)-224(3), the CGRA configuration circuit 200 includes an instruction decoding circuit 234. The instruction decoding circuit 234 is configured to receive the dataflow instruction block 206 from the block-based dataflow computer processor core 100, as indicated by arrows 236 and 238. The instruction decoding circuit 234 then maps each of the dataflow instructions 204(0)-204(X) to one of the tiles 208(0)-208(3) of the CGRA 202. It is to be understood that the CGRA 202 is configured to provide a number of tiles 208(0)-208(3) equal to or greater than a number of dataflow instructions 204(0)-204(X) within the dataflow instruction block 206. Some aspects may provide that mapping the dataflow instructions 204(0)-204(X) to the tiles 208(0)-208(3) may comprise deriving a column coordinate and a row coordinate for one of the tiles 208(0)-208(3) within the CGRA 202 based on instruction slot numbers or other indices (not shown) for the dataflow instructions 204(0)-204(X). As a non-limiting example, a column coordinate may be calculated as the modulus of the instruction slot number of one of the dataflow instructions 204(0)-204(X) and the width of the CGRA 202, while a row coordinate may be calculated as the integer result of dividing the instruction slot number and the width of the CGRA 202. Thus, for instance, if the instruction slot number of the dataflow instruction 204(2) is two (2), the instruction decoding circuit 234 may map the dataflow instruction 204(2) to the tile 208(2) (i.e., tile 0,1). It is to be understood that other approaches for mapping each of the dataflow instructions 204(0)-204(X) to one of the tiles 208(0)-208(3) may be employed.

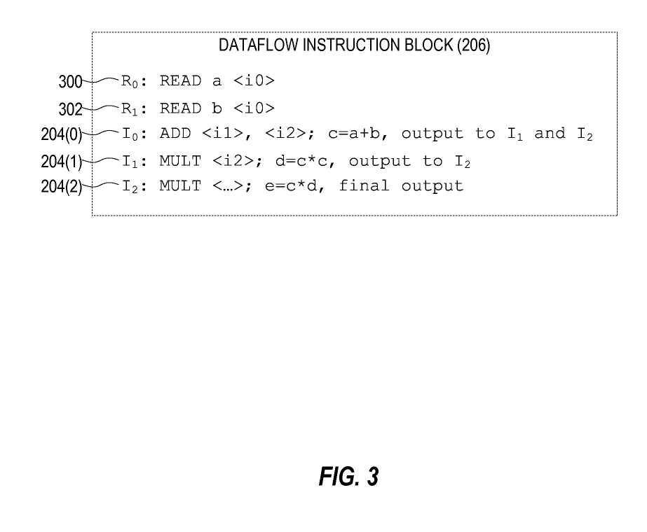

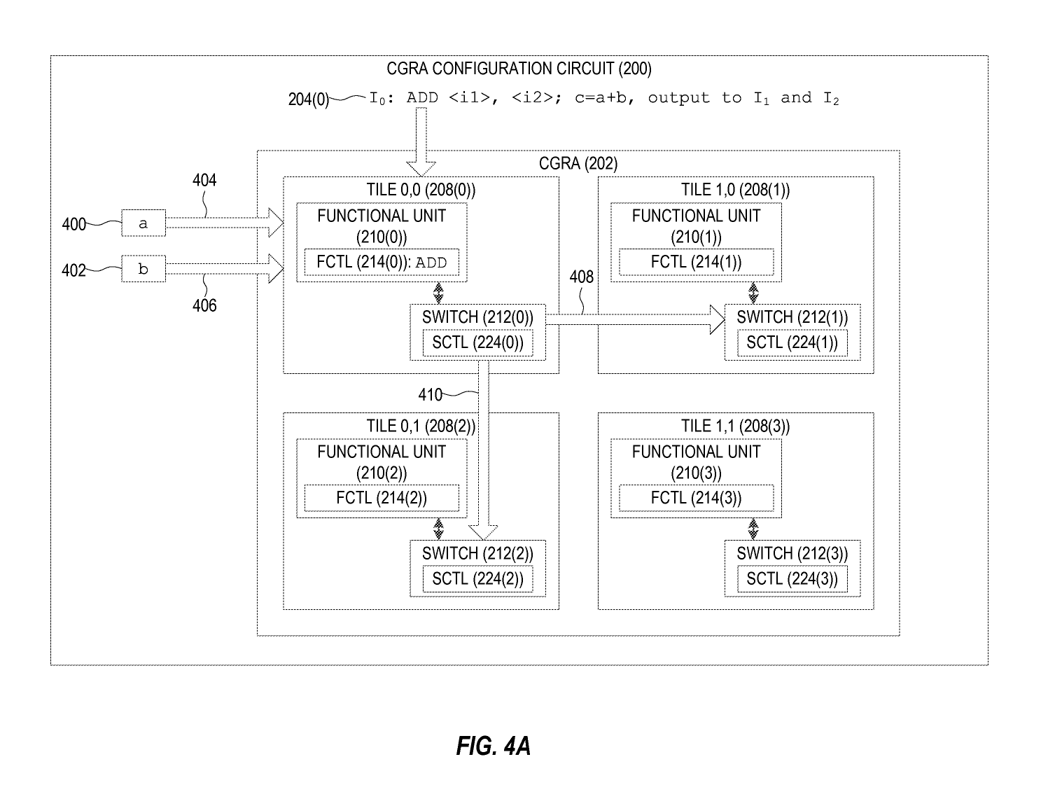

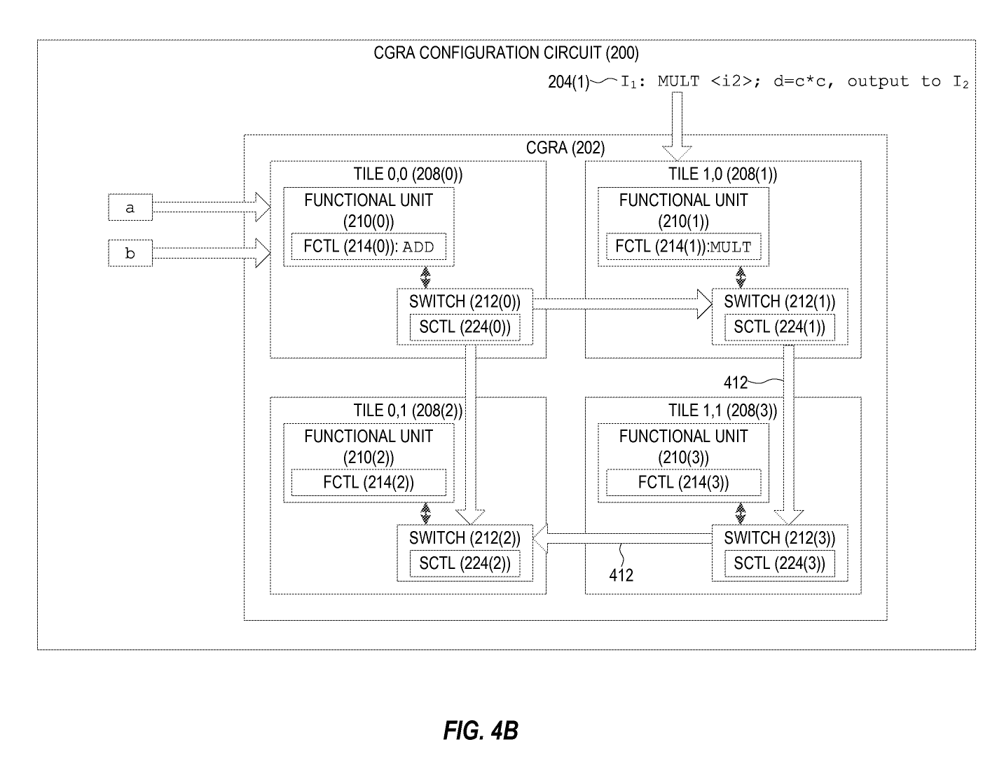

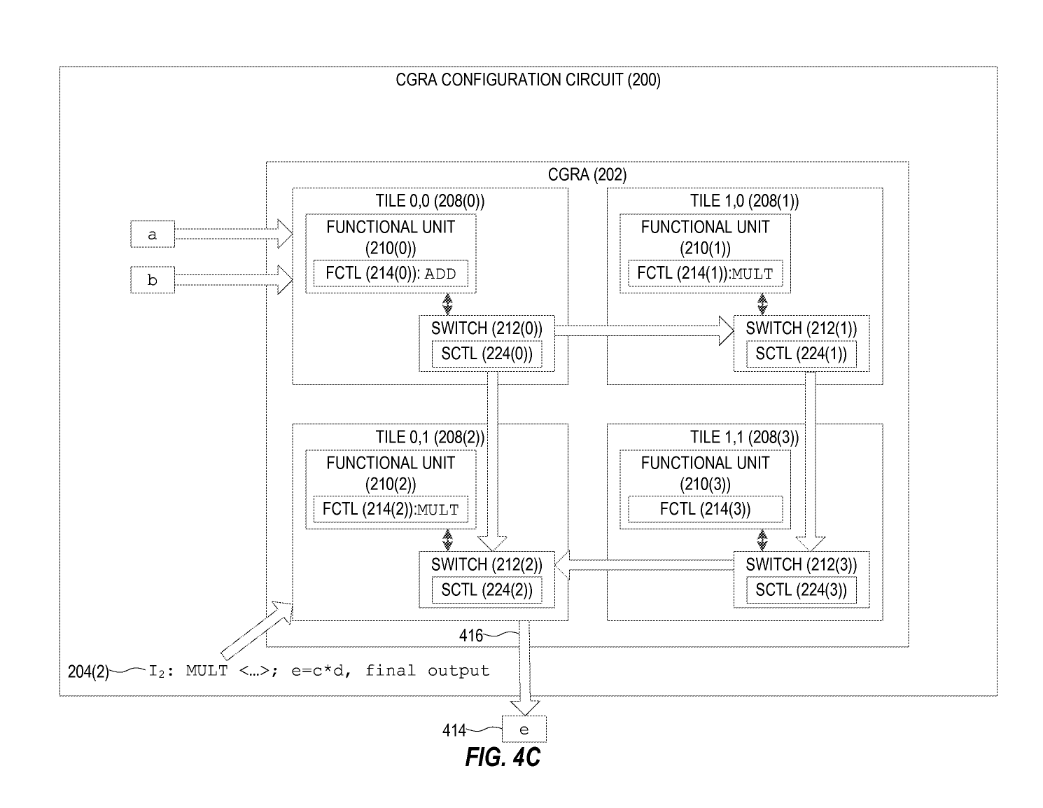

The instruction decoding circuit 234 next decodes each of the dataflow instructions 204(0)-204(X). In some aspects, the dataflow instructions 204(0)-204(X) are processed serially, while some aspects of the instruction decoding circuit 234 may be configured to process multiple dataflow instructions 204(0)-204(X) in parallel. Based on the decoding, the instruction decoding circuit 234 generates the function control configurations 214(0)-214(3) corresponding to the tiles 208(0)-208(3) to which the dataflow instructions 204(0)-204(X) are mapped. Each of the function control configurations 214(0)-214(3) configures the corresponding functional unit 210(0)-210(3) of the associated tile 208(0)-208(3) to perform a same operation as the dataflow instruction 204(0)-204(X) mapped to the tile 208(0)-208(3). The instruction decoding circuit 234 further generates the switch control configurations 224(0)-224(3) for the switches 212(0)-212(3) of the tiles 208(0)-208(3) to ensure that an output (not shown), if any, of each functional unit 210(0)-210(3) is routed to one of the tiles 208(0)-208(3) to which a consumer dataflow instruction 204(0)-204(X) is mapped. Operations for mapping and decoding the dataflow instructions 204(0)-204(X) and generating the function control configurations 214(0)-214(3) and the switch control configurations 224(0)-224(3) are discussed in greater detail below with respect to FIGS. 3 and 4A-4C.

In some aspects, the function control configurations 214(0)-214(3) and the switch control configurations 224(0)-224(3) may be streamed directly into the CGRA 202 by the instruction decoding circuit 234, as indicated by arrow 240. The function control configurations 214(0)-214(3) and the switch control configurations 224(0)-224(3) may be provided to the CGRA 202 as they are generated by the instruction decoding circuit 234, or a subset or an entire set of the function control configurations 214(0)-214(3) and the switch control configurations 224(0)-224(3) may be provided at the same time to the CGRA 202. Some aspects may provide that the function control configurations 214(0)-214(3) and the switch control configurations 224(0)-224(3) generated by the instruction decoding circuit 234 may be output to a CGRA configuration buffer 242, as indicated by arrow 244. The CGRA configuration buffer 242 according to some aspects may comprise a memory array (not shown) indexed with coordinates of the tiles 208(0)-208(3), and configured to store the function control configurations 214(0)-214(3) and the switch control configurations 224(0)-224(3) for the corresponding tiles 208(0)-208(3). The function control configurations 214(0)-214(3) and the switch control configurations 224(0)-224(3) may then be provided to the CGRA 202 at a later time, as indicated by arrow 246.

In the example of FIG. 2, the instruction decoding circuit 234 comprises a centralized circuit that implements a hardware state machine (not shown) for processing the dataflow instructions 204(0)-204(X) of the dataflow instruction block 206. However, in some aspects, functionality of the instruction decoding circuit 234 for generating the function control configurations 214(0)-214(3) and the switch control configurations 224(0)-224(3) may be distributed within the tiles 208(0)-208(3) of the CGRA 202. In this regard, the tiles 208(0)-208(3) of the CGRA 202 according to some aspects may provide distributed decoder units 248(0)-248(3). The instruction decoding circuit 234 in such aspects may map the dataflow instructions 204(0)-204(X) to the tiles 208(0)-208(3) of the CGRA 202. Each of the distributed decoder unit 248(0)-248(3) may be configured to receive and decode one of the dataflow instructions 204(0)-204(X) from the instruction decoding circuit 234, and generate a corresponding function control configuration 214(0)-214(3) and switch control configuration 224(0)-224(3) for its associated tile 208(0)-208(3).

Some aspects may provide that the CGRA configuration circuit 200 is configured to select, at runtime, either the CGRA 202 or the block-based dataflow computer processor core 100 to execute the dataflow instruction block 206. As a non-limiting example, the CGRA configuration circuit 200 may determine, at runtime, whether the instruction decoding circuit 234 was successful in generating the function control configurations 214(0)-214(3) and the switch control configurations 224(0)-224(3). If the function control configurations 214(0)-214(3) and the switch control configurations 224(0)-224(3) were successfully generated, the CGRA configuration circuit 200 selects the CGRA 202 to execute the dataflow instruction block 206. However, if the instruction decoding circuit 234 was unsuccessful in generating the function control configurations 214(0)-214(3) and the switch control configurations 224(0)-224(3) (e.g., because of an error during decoding), the CGRA configuration circuit 200 selects the block-based dataflow computer processor core 100 to execute the dataflow instruction block 206. In some aspects, the CGRA configuration circuit 200 may also select the block-based dataflow computer processor core 100 to execute the dataflow instruction block 206 if it determines, at runtime, that the CGRA 202 does not provide a required resource needed to execute the dataflow instruction block 206. For instance, the CGRA configuration circuit 200 may determine that the CGRA 202 lacks a sufficient number of functional units 210(0)-210(3) that support a particular operation. In this manner, the CGRA configuration circuit 200 may provide a mechanism for ensuring that the dataflow instruction block 206 is successfully executed.

To provide a simplified illustration of operations for mapping and decoding the dataflow instructions 204(0)-204(X) and generating the function control configurations 214(0)-214(3) and the switch control configurations 224(0)-224(3) of FIG. 2, FIGS. 3 and 4A-4C are provided. FIG. 3 provides an exemplary dataflow instruction block 206 comprising the sequence of dataflow instructions 204(0)-204(2) to be processed by the CGRA configuration circuit 200 of FIG. 2. FIGS. 4A-4C illustrate exemplary elements and communications flows within the CGRA configuration circuit 200 of FIG. 2 during processing of the dataflow instructions 204(0)-204(2) to configure the CGRA 202. For the sake of brevity, elements of FIG. 2 are referenced in describing FIGS. 3 and 4A-4C.

In FIG. 3, a simplified exemplary dataflow instruction block 206 includes two READ operations 300 and 302 (also referred to as R₀ and R₁, respectively) and three (3) dataflow instructions 204(0), 204(1), and 204(2) (referred to as I₀, I₁, and I₂, respectively). The READ operations 300 and 302 represent operations for providing input values a and b to the dataflow instruction block 206, and thus are not considered dataflow instructions 204 for purposes of this example. The READ operation 300 provides the value a as a first operand to the dataflow instruction I₀ 204(0), while the READ operation 302 provides the value b as a second operand to the dataflow instruction I₀ 204(0).

As noted above, in dataflow instruction block execution, each of the dataflow instructions 204(0)-204(2) may execute as soon as all of its input operands are available. In the dataflow instruction block 206 shown in FIG. 3, once values a and b are provided to the dataflow instruction I₀ 204(0), the dataflow instruction I₀ 204(0) may proceed with execution. The dataflow instruction I₀ 204(0) in this example is an ADD instruction that sums the input values a and b, and provides the result c as input operands to both the dataflow instruction I₁ 204(1) and the dataflow instruction I₂ 204(2). Upon receiving the result c, the dataflow instruction I₁ 204(1) executes. In the example of FIG. 3, the dataflow instruction I₁ 204(1) is a MULT instruction that multiplies the value c by itself, and provides the result d to the dataflow instruction I₂ 204(2). The dataflow instruction I₂ 204(2) can execute only after it receives its input operands from both the dataflow instruction I₀ 204(0) and the dataflow instruction I₁ 204(1). The dataflow instruction I₂ 204(2) is a MULT instruction that multiplies the values c and d, and provides the final output value e.

Referring now to FIG. 4A, processing of the dataflow instruction block 206 of FIG. 3 by the CGRA configuration circuit 200 begins. For the sake of clarity, some elements of the CGRA configuration circuit 200 shown in FIG. 2, such as the instruction decoding circuit 234, are omitted from FIGS. 4A-4C. As seen in FIG. 4A, the CGRA configuration circuit 200 first maps the dataflow instruction I₀ 204(0) to the tile 208(0) (also referred to herein as the “mapped tile 208(0)”) of the CGRA 202. The CGRA configuration circuit 200 configures the CGRA 202 to provide values a 400 and b 402 as inputs 404 and 406, respectively, to the mapped tile 208(0). The instruction decoding circuit 234 of the CGRA configuration circuit 200 decodes the dataflow instruction I₀ 204(0), and then generates the function control configuration 214(0) to correspond to the ADD functionality of the dataflow instruction I₀ 204(0).

The instruction decoding circuit 234 of the CGRA configuration circuit 200 next analyzes the dataflow instruction I₀ 204(0) to identify its consumer instructions. In this example, the dataflow instruction I₀ 204(0) provides its output to both the dataflow instruction I₁ 204(1) and the dataflow instruction I₂ 204(2) (also referred to as “consumer instructions 204(1) and 204(2)”). Based on its analysis, the CGRA configuration circuit 200 identifies the destination tiles 208(1) and 208(2) (i.e., the tiles 208(0)-208(3) to which the output of the functional unit 210(0) should be sent) to which the consumer instructions 204(1) and 204(2), respectively, are mapped. The CGRA configuration circuit 200 then determines one or more tiles 208(0)-208(3) (referred to herein as “path tiles”) that comprise a path from the mapped tile 208(0) to each of the destination tiles 208(1) and 208(2). The “path tiles” represent each tile 208(0)-208(3) of the CGRA 202 for which a switch 212(0)-212(3) must be configured in order to route the output of the functional unit 210(0) to the destination tiles 208(1) and 208(2). In some aspects, the path tiles may be determined by determining a shortest Manhattan distance between the mapped tile 208(0) and each of the destination tiles 208(1) and 208(2).

In the example of FIG. 4A, the destination tiles 208(1) and 208(2) are located immediately adjacent to the mapped tile 208(0), so the mapped tile 208(0) and the destination tiles 208(1) and 208(2) are the only path tiles for which switch configuration is necessary. The instruction decoding circuit 234 of the CGRA configuration circuit 200 thus generates the switch control configuration 224(0) of the switch 212(0) of the mapped tile 208(0) to route an output 408 to the switch 212(1) of the destination tile 208(1), and generates the switch control configuration 224(1) of the switch 212(1) to receive the output 408 as input. The CGRA configuration circuit 200 also generates the switch control configuration 224(0) of the switch 212(0) of the mapped tile 208(0) to route an output 410 to the switch 212(2) of the destination tile 208(2), and generates the switch control configuration 224(2) of the switch 212(2) to receive the output 410 as input.

In FIG. 4B, the instruction decoding circuit 234 of the CGRA configuration circuit 200 maps the dataflow instruction I₁ 204(1) to the mapped tile 208(1). The instruction decoding circuit 234 of the CGRA configuration circuit 200 decodes the dataflow instruction I₁ 204(1), and generates the function control configuration 214(1) to correspond to the MULT functionality of the dataflow instruction I₁ 204(1). The CGRA configuration circuit 200 then identifies the dataflow instruction I₂ 204(2) as a consumer instruction 204(2) for the dataflow instruction I₁ 204(1), and further identifies the destination tile 208(2) to which the consumer instruction 204(2) is mapped.

As seen in FIG. 4B, the destination tile 208(2) is not immediately adjacent to the mapped tile 208(1). Accordingly, the CGRA configuration circuit 200 determines a path from the mapped tile 208(1) to the destination tile 208(2) through an intermediate tile 208(3). The path thus includes the mapped tile 208(1), the intermediate tile 208(3), and the destination tile 208(2) as path tiles 208(1), 208(3), and 208(2), respectively. The instruction decoding circuit 234 of the CGRA configuration circuit 200 then generates the switch control configuration 224(1) of the switch 212(1) of the mapped tile 208(1) to route an output 412 from the functional unit 210(1) to the switch 212(3) of the path tile 208(3). The CGRA configuration circuit 200 also generates the switch control configuration 224(3) of the switch 212(3) to receive the output 412 as input. The CGRA configuration circuit 200 further generates the switch control configuration 224(3) of the switch 212(3) of the mapped tile 208(3) to route the output 412 to the switch 212(2) of the destination tile 208(2), and generates the switch control configuration 224(2) of the switch 212(2) of the destination tile 208(2) to receive the output 412 as input from the switch 212(3). The switch control configuration 224(2) also configures the switch 212(2) to provide the output 412 to the functional unit 210(2) of the destination tile 208(2).

Referring now to FIG. 4C, the instruction decoding circuit 234 of the CGRA configuration circuit 200 next maps the dataflow instruction I₂ 204(2) to the mapped tile 208(2), and decodes the dataflow instruction I₂ 204(2). The function control configuration 214(2) is then generated to correspond to the MULT functionality of the dataflow instruction I₂ 204(2). In this simplified example, the dataflow instruction I₂ 204(2) is the last instruction in the dataflow instruction block 206 of FIG. 3. Accordingly, the CGRA configuration circuit 200 configures the switch control configuration 224(2) of the switch 212(2) to provide a value e 414 as an output 416 to the block-based dataflow computer processor core 100 of FIG. 2.

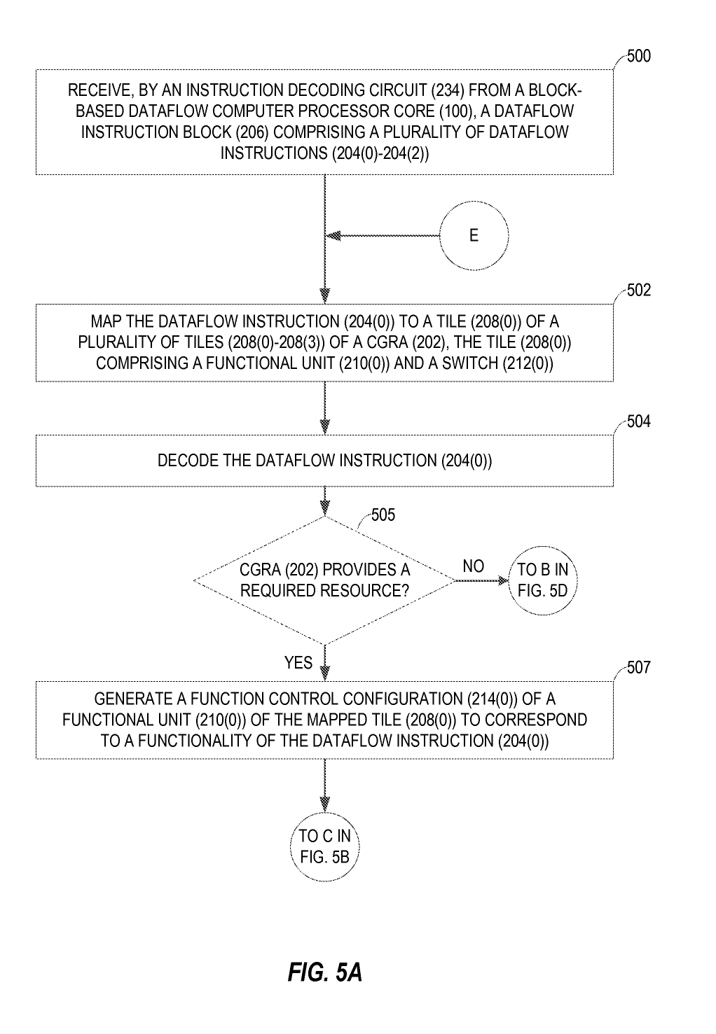

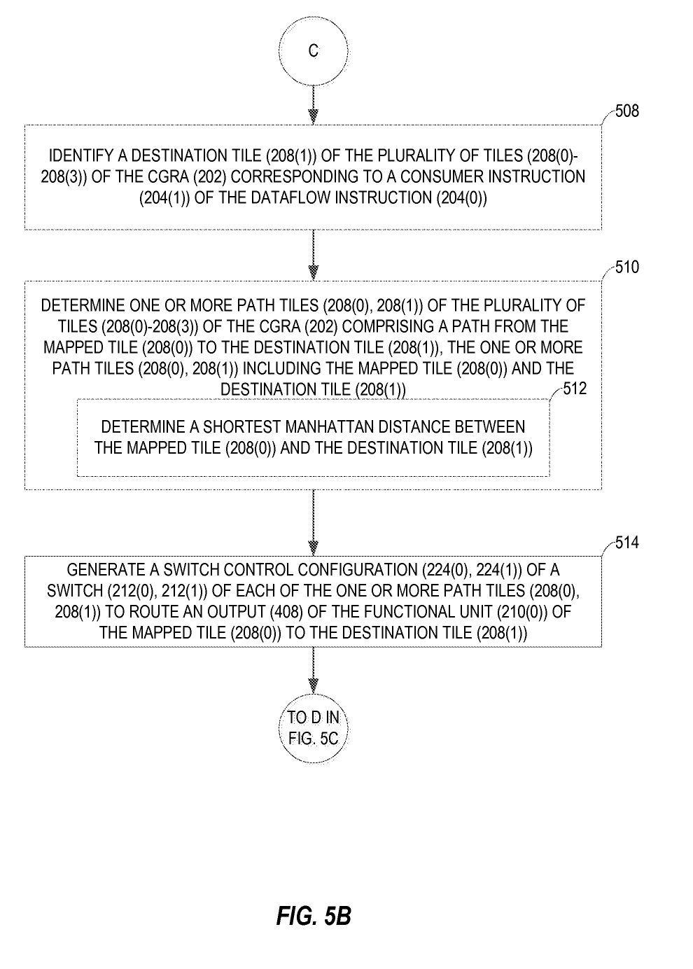

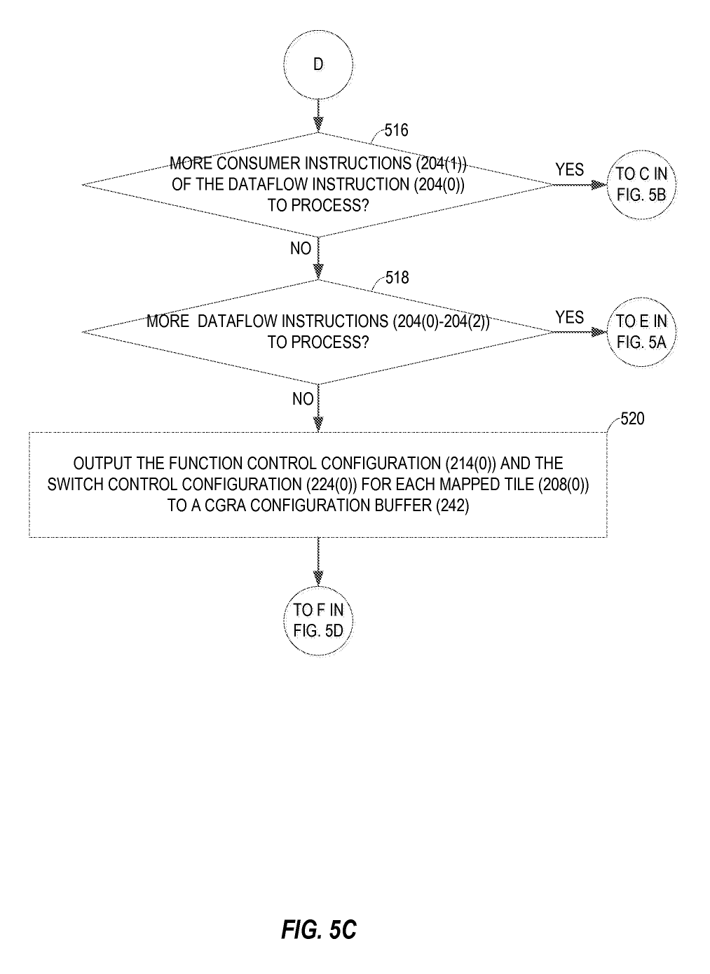

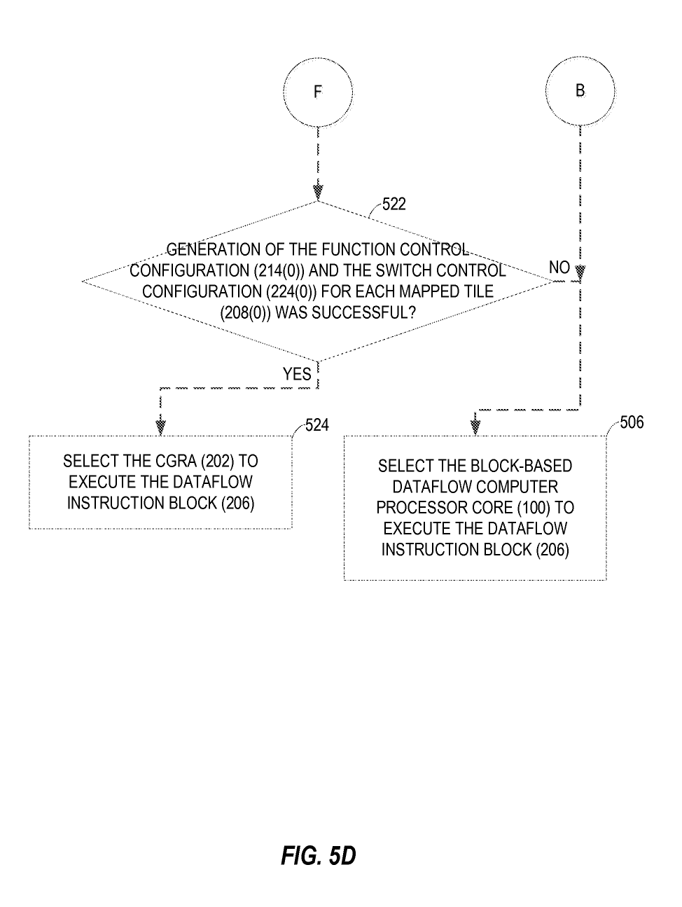

FIGS. 5A-5D are flowcharts provided to illustrate exemplary operations of the CGRA configuration circuit 200 of FIG. 2 for configuring the CGRA 202 for dataflow instruction block execution. In describing FIGS. 5A-5D, elements of FIGS. 2, 3, and 4A-4C are referenced for the sake of clarity. In FIG. 5A, operations begin with the instruction decoding circuit 234 of the CGRA configuration circuit 200 receiving the dataflow instruction block 206 comprising the plurality of dataflow instructions 204(0)-204(2) from the block-based dataflow computer processor core 100 (block 500). Accordingly, the instruction decoding circuit 234 may be referred to herein as “a means for receiving a dataflow instruction block comprising a plurality of dataflow instructions.” The instruction decoding circuit 234 then performs the following series of operations on each of the dataflow instructions 204(0)-204(2). The instruction decoding circuit 234 maps the dataflow instruction 204(0) to a tile 208(0) of the plurality of tiles 208(0)-208(3) of the CGRA 202, with the tile 208(0) comprising a functional unit 210(0) and a switch 212(0) (block 502). In this regard, the instruction decoding circuit 234 may be referred to herein as “a means for mapping the dataflow instruction to a tile of a plurality of tiles of the CGRA.” The dataflow instruction 204(0) is then decoded by the instruction decoding circuit 234 (block 504). The instruction decoding circuit 234 may thus be referred to herein as “a means for decoding the dataflow instruction.”

In some aspects, the instruction decoding circuit 234 may determine whether the CGRA 202 provides a required resource (block 505). Accordingly, the instruction decoding circuit 234 may be referred to herein as “a means for determining, at runtime, whether the CGRA provides a required resource.” The required resource may comprise, for example, a sufficient number of functional units 210(0)-210(3) within the CGRA 202 that support a particular operation. If it is determined at decision block 505 that the CGRA 202 does not provide the required resource, processing proceeds to block 506 of FIG. 5D. If the instruction decoding circuit 234 determines at decision block 505 that the CGRA 202 does provide the required resource, the instruction decoding circuit 234 generates the function control configuration 214(0) of the functional unit 210(0) of the mapped tile 208(0) to correspond to a functionality of the dataflow instruction 204(0) (block 507). Accordingly, the instruction decoding circuit 234 may be referred to herein as “a means for generating a function control configuration of a functional unit of the mapped tile.” Processing then resumes at block 508 of FIG. 5B.

Referring now to FIG. 5B, the instruction decoding circuit 234 next performs the following operations for each consumer instruction 204(1), 204(2) of the dataflow instruction 204(0). The instruction decoding circuit 234 in some aspects may identify a destination tile (e.g., 208(1)) of the plurality of tiles 208(0)-208(3) of the CGRA 202 corresponding to the consumer instruction (e.g., 204(1)) (block 508). In this regard, the instruction decoding circuit 234 may be referred to herein as “a means for identifying a destination tile of the plurality of tiles of the CGRA corresponding to the consumer instruction.” The instruction decoding circuit 234 may then determine one or more path tiles (e.g., 208(0), 208(1)) of the plurality of tiles 208(0)-208(3) of the CGRA 202 comprising a path from the mapped tile (e.g., 208(0)) to the destination tile (e.g., 208(1)), the one or more path tiles (e.g., 208(0), 208(1)) including the mapped tile (e.g., 208(0)) and the destination tile (e.g., 208(1)) (block 510). The instruction decoding circuit 234 may thus be referred to herein as “a means for determining one or more path tiles of the plurality of tiles of the CGRA comprising a path from the mapped tile to the destination tile.” In some aspects, determining the one or more path tiles (e.g., 208(0), 208(1)) may comprise determining a shortest Manhattan distance between the mapped tile (e.g., 208(0)) and the destination tile (e.g., 208(1)) (block 512). The instruction decoding circuit 234 next generates a switch control configuration (e.g., 224(0), 224(1)) of a switch (e.g., 212(0), 212(1)) of each of the one or more path tiles (e.g., 208(0), 208(1)) to route an output (e.g., 408) of the functional unit (e.g., 210(0)) of the mapped tile (e.g., 208(0)) to the destination tile (e.g., 208(1)) (block 514). Accordingly, the instruction decoding circuit 234 may be referred to herein as “a means for generating a switch control configuration of a switch of each of the one or more path tile.” Processing then continues at block 516 of FIG. 5C.

In FIG. 5C, the instruction decoding circuit 234 determines whether there exist more consumer instructions (e.g., 204(1)) of the dataflow instruction (e.g., 204(0)) to process (block 516). If so, processing resumes at block 508 in FIG. 5B. However, if the instruction decoding circuit 234 determines at decision block 516 that there are no more consumer instructions (e.g., 204(1)) to process, the instruction decoding circuit 234 determines whether there exist more dataflow instructions 204(0)-204(2) to process (block 518). If more dataflow instructions 204(0)-204(2) exist, processing resumes at block 502 in FIG. 5A. If the instruction decoding circuit 234 determines at decision block 518 that all dataflow instructions 204(0)-204(2) have been processed, the instruction decoding circuit 234 in some aspects, may output the function control configuration (e.g., 214(0)) and the switch control configuration (e.g., 224(0)) for each mapped tile (e.g., 208(0)) to a CGRA configuration buffer 242 (block 520). In this regard, the instruction decoding circuit 234 may be referred to herein as “a means for outputting the function control configuration and the switch control configuration for each mapped tile to a CGRA configuration buffer.” Processing optionally may resume at block 522 of FIG. 5D.

Turning to FIG. 5D, the instruction decoding circuit 234 according to some aspects may determine whether generation of the function control configuration (e.g., 214(0)) and the switch control configuration (e.g., 224(0)) for each mapped tile (e.g., 208(0)) was successful (block 522). The instruction decoding circuit 234 thus may be referred to herein as “a means for determining, at runtime, whether generation of the function control configuration and the switch control configuration for each mapped tile was successful.” If generation of the function control configuration (e.g., 214(0)) and the switch control configuration (e.g., 224(0)) for each mapped tile (e.g., 208(0)) was unsuccessful, the instruction decoding circuit 234 may select the block-based dataflow computer processor core 100 to execute the dataflow instruction block 206 (block 506). If the instruction decoding circuit 234 determines at decision block 526 that the function control configuration (e.g., 214(0)) and the switch control configuration (e.g., 224(0)) for each mapped tile (e.g., 208(0)) were successfully generated, the instruction decoding circuit 234 may select the CGRA 202 to execute the dataflow instruction block 206 (block 524). Accordingly, the instruction decoding circuit 234 may be referred to herein as “a means for selecting, at runtime, one of the CGRA and the block-based dataflow computer processor core to execute the dataflow instruction block.”

Configuring CGRAs for dataflow instruction block execution in block-based dataflow ISAs according to aspects disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

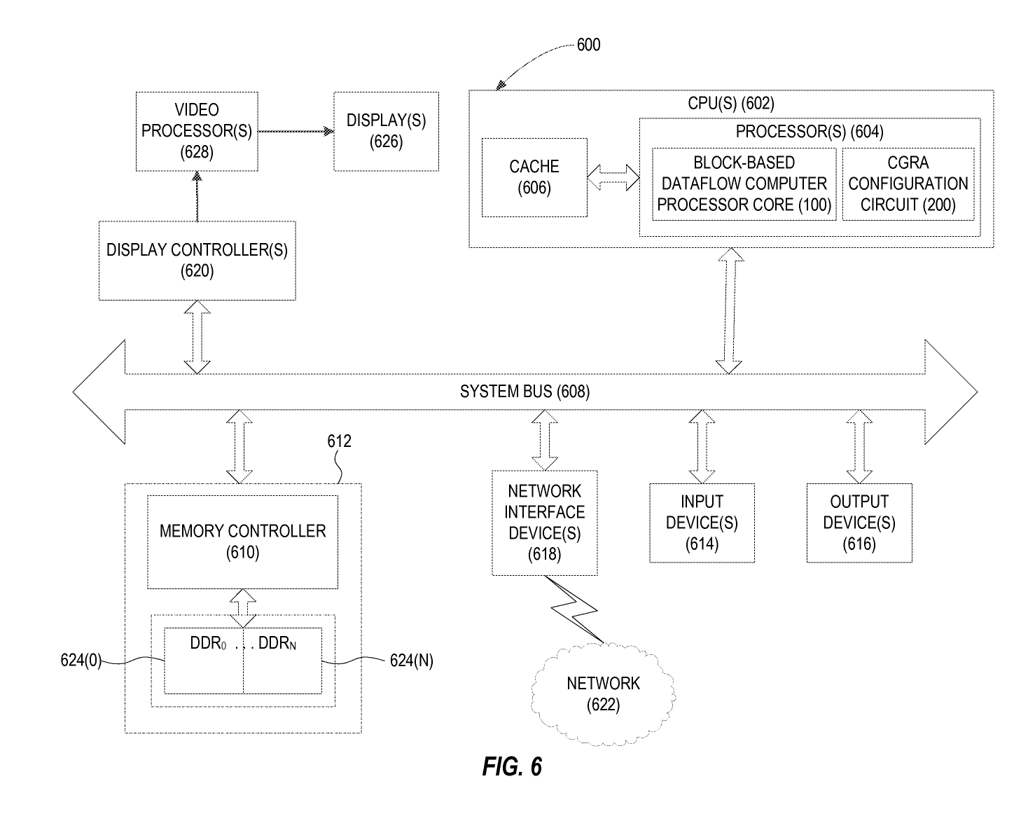

In this regard, FIG. 6 illustrates an example of a processor-based system 600 that can employ the block-based dataflow computer processor core 100 of FIG. 1 with the CGRA configuration circuit 200 of FIG. 2. In this example, the processor-based system 600 includes one or more central processing units (CPUs) 602, each including one or more processors 604. As seen in FIG. 6, the one or more processors 604 may each comprise the block-based dataflow computer processor core 100 of FIG. 1 and the CGRA configuration circuit 200 of FIG. 2. The CPU(s) 602 may have cache memory 606 coupled to the processor(s) 604 for rapid access to temporarily stored data. The CPU(s) 602 is coupled to a system bus 608 and can intercouple devices included in the processor-based system 600. As is well known, the CPU(s) 602 communicates with these other devices by exchanging address, control, and data information over the system bus 608. For example, the CPU(s) 602 can communicate bus transaction requests to a memory controller 610 as an example of a slave device. Although not illustrated in FIG. 6, multiple system buses 608 could be provided.

Other devices can be connected to the system bus 608. As illustrated in FIG. 6, these devices can include a memory system 612, one or more input devices 614, one or more output devices 616, one or more network interface devices 618, and one or more display controllers 620, as examples. The input device(s) 614 can include any type of input device, including but not limited to input keys, switches, voice processors, etc. The output device(s) 616 can include any type of output device, including but not limited to audio, video, other visual indicators, etc. The network interface device(s) 618 can be any devices configured to allow exchange of data to and from a network 622. The network 622 can be any type of network, including but not limited to a wired or wireless network, a private or public network, a local area network (LAN), a wide local area network (WAN), wireless local area network (WLAN), BLUETOOTH™, and the Internet. The network interface device(s) 618 can be configured to support any type of communications protocol desired. The memory system 612 can include one or more memory units 624(0)-624(N).

The CPU(s) 602 may also be configured to access the display controller(s) 620 over the system bus 608 to control information sent to one or more displays 626. The display controller(s) 620 sends information to the display(s) 626 to be displayed via one or more video processors 628, which process the information to be displayed into a format suitable for the display(s) 626. The display(s) 626 can include any type of display, including but not limited to a cathode ray tube (CRT), a liquid crystal display (LCD), a light emitting diode (LED) display, a plasma display, etc.

Those of skill in the art will further appreciate that the various illustrative logical blocks, modules, circuits, and algorithms described in connection with the aspects disclosed herein may be implemented as electronic hardware. The devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A coarse-grained reconfigurable array (CGRA) configuration circuit of a block-based dataflow instruction set architecture (ISA), comprising:
a CGRA comprising a plurality of tiles, each tile among of the plurality of tiles comprising a functional unit and a switch; and
an instruction decoding circuit configured to:
receive, from a block-based dataflow computer processor core, a dataflow instruction block comprising a plurality of dataflow instructions; and
for each dataflow instruction of the plurality of dataflow instructions:
map the dataflow instruction to a tile of the plurality of tiles of the CGRA;
decode the dataflow instruction;
generate a function control configuration for the functional unit of the mapped tile to correspond to a functionality of the dataflow instruction; and
for each consumer instruction of the dataflow instruction, generate a switch control configuration of the switch of each of one or more path tiles of the plurality of tiles of the CGRA to route an output of the functional unit of the mapped tile to a destination tile of the plurality of tiles of the CGRA corresponding to the consumer instruction.

2. The CGRA configuration circuit of claim 1, wherein the instruction decoding circuit is further configured to, prior to generating the switch control configuration:
identify the destination tile of the plurality of tiles of the CGRA corresponding to the consumer instruction;
determine the one or more path tiles of the plurality of tiles of the CGRA comprising a path from the mapped tile to the destination tile, the one or more path tiles including the mapped tile and the destination tile.

3. The CGRA configuration circuit of claim 2, wherein the instruction decoding circuit is configured to determine the one or more path tiles of the plurality of tiles of the CGRA comprising the path from the mapped tile to the destination tile by determining a shortest Manhattan distance between the mapped tile and the destination tile.

4. The CGRA configuration circuit of claim 2, wherein the functional unit of each tile among the plurality of tiles comprises logic for providing a plurality of word-level operations; and
the functional unit is configured to selectively perform a word-level operation of the plurality of word-level operations responsive to the generated function control configuration.

5. The CGRA configuration circuit of claim 2, wherein the switch of each tile among the plurality of tiles is communicatively coupled to the functional unit of the tile and to a plurality of switches of the corresponding plurality of tiles; and
the switch is configured to transmit data among the functional unit and one or more of the plurality of switches of the corresponding plurality of tiles responsive to the generated switch control configuration.

6. The CGRA configuration circuit of claim 2, wherein the consumer instruction comprises an instruction that receives an output of the dataflow instruction as an input.

7. The CGRA configuration circuit of claim 1, wherein:
the instruction decoding circuit further comprises a centralized hardware state machine; and
the instruction decoding circuit is further configured to output the function control configuration and the switch control configuration for each mapped tile to a CGRA configuration buffer.

8. The CGRA configuration circuit of claim 1, wherein:
the instruction decoding circuit further comprises a plurality of distributed decoder units, each integrated into a tile of the plurality of tiles of the CGRA; and
the instruction decoding circuit is configured to decode each dataflow instruction and generate the function control configuration and the switch control configuration for each mapped tile using a distributed decoder unit of the plurality of distributed decoder units corresponding to the mapped tile.

9. The CGRA configuration circuit of claim 1, wherein the instruction decoding circuit is further configured to select, at runtime, one of the CGRA and the block-based dataflow computer processor core to execute the dataflow instruction block.

10. The CGRA configuration circuit of claim 9, wherein the instruction decoding circuit is further configured to determine, at runtime, whether generation of the function control configuration and the switch control configuration for each mapped tile was successful;
the instruction decoding circuit configured to:
select the CGRA to execute the dataflow instruction block responsive to determining that the generation of the function control configuration and the switch control configuration for each mapped tile was successful; and
select the block-based dataflow computer processor core to execute the dataflow instruction block responsive to determining that the generation of the function control configuration and the switch control configuration for each mapped tile was not successful.

11. The CGRA configuration circuit of claim 9, wherein the instruction decoding circuit is further configured to detect, at runtime, whether the CGRA provides a required resource;
the instruction decoding circuit configured to:
select the CGRA to execute the dataflow instruction block responsive to determining that the CGRA provides the required resource; and
select the block-based dataflow computer processor core to execute the dataflow instruction block responsive to determining that the CGRA does not provide the required resource.

12. The CGRA configuration circuit of claim 1 integrated into an integrated circuit (IC).

13. The CGRA configuration circuit of claim 1 integrated into a device selected from the group consisting of: a set top box; an entertainment unit; a navigation device; a communications device; a fixed location data unit; a mobile location data unit; a mobile phone; a cellular phone; a computer; a portable computer; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; and a portable digital video player.

14. A method for configuring a coarse-grained reconfigurable array (CGRA) for dataflow instruction block execution in a block-based dataflow instruction set architecture (ISA), comprising:
receiving, by an instruction decoding circuit from a block-based dataflow computer processor core, a dataflow instruction block comprising a plurality of dataflow instructions; and
for each dataflow instruction of the plurality of dataflow instructions:
mapping the dataflow instruction to a tile of a plurality of tiles of a CGRA, each tile among of the plurality of tiles comprising a functional unit and a switch;
decoding the dataflow instruction;
generating a function control configuration for the functional unit of the mapped tile to correspond to a functionality of the dataflow instruction; and
for each consumer instruction of the dataflow instruction, generating a switch control configuration of the switch of each of one or more path tiles of the plurality of tiles of the CGRA to route an output of the functional unit of the mapped tile to a destination tile of the plurality of tiles of the CGRA corresponding to the consumer instruction.

15. The method of claim 14, further comprising, prior to generating the switch control configuration:
identifying the destination tile of the plurality of tiles of the CGRA corresponding to the consumer instruction; and
determining the one or more path tiles of the plurality of tiles of the CGRA comprising a path from the mapped tile to the destination tile, the one or more path tiles including the mapped tile and the destination tile.

16. The method of claim 15, wherein determining the one or more path tiles of the plurality of tiles of the CGRA comprising the path from the mapped tile to the destination tile comprises determining a shortest Manhattan distance between the mapped tile and the destination tile.

17. The method of claim 14, wherein:
the instruction decoding circuit comprises a centralized hardware state machine; and
the method further comprises outputting the function control configuration and the switch control configuration for each mapped tile to a CGRA configuration buffer.

18. The method of claim 14, wherein:
the instruction decoding circuit comprises a plurality of distributed decoder units, each integrated into a tile of the plurality of tiles of the CGRA; and
the method further comprises decoding each dataflow instruction and generating the function control configuration and the switch control configuration for each mapped tile using a distributed decoder unit of the plurality of distributed decoder units corresponding to the mapped tile.

19. The method of claim 14, further comprising selecting, at runtime, one of the CGRA and the block-based dataflow computer processor core to execute the dataflow instruction block.

20. The method of claim 19, further comprising determining, at runtime, whether generation of the function control configuration and the switch control configuration for each mapped tile was successful;
the method comprising:
selecting the CGRA to execute the dataflow instruction block responsive to determining that the generation of the function control configuration and the switch control configuration for each mapped tile was successful; and
selecting the block-based dataflow computer processor core to execute the dataflow instruction block responsive to determining that the generation of the function control configuration and the switch control configuration for each mapped tile was not successful.

21. The method of claim 19, further comprising determining, at runtime, whether the CGRA provides a required resource;
the method comprising:
selecting the CGRA to execute the dataflow instruction block responsive to determining that the CGRA provides the required resource; and
selecting the block-based dataflow computer processor core to execute the dataflow instruction block responsive to determining that the CGRA does not provide the required resource.

22. A coarse-grained reconfigurable array (CGRA) configuration circuit of a block-based dataflow instruction set architecture (ISA) for configuring a CGRA comprising a plurality of tiles, each tile among of the plurality of tiles comprising a functional unit and a switch, comprising:
a means for receiving, from a block-based dataflow computer processor core, a dataflow instruction block comprising a plurality of dataflow instructions; and
for each dataflow instruction of the plurality of dataflow instructions:
a means for mapping the dataflow instruction to a tile of a plurality of tiles of a CGRA;
a means for decoding the dataflow instruction;
a means for generating a function control configuration of the functional unit of the mapped tile to correspond to a functionality of the dataflow instruction; and
for each consumer instruction of the dataflow instruction, a means for generating a switch control configuration of the switch of each of one or more path tiles of the plurality of tiles of the CGRA to route an output of the functional unit of the mapped tile to a destination tile of the plurality of tiles of the CGRA corresponding to the consumer instruction.

23. The CGRA configuration circuit of claim 22, further comprising:
a means for identifying the destination tile of the plurality of tiles of the CGRA corresponding to the consumer instruction prior to generating the switch control configuration; and
a means for determining the one or more path tiles of the plurality of tiles of the CGRA comprising a path from the mapped tile to the destination tile, the one or more path tiles including the mapped tile and the destination tile.

24. The CGRA configuration circuit of claim 23, wherein the means for determining the one or more path tiles of the plurality of tiles of the CGRA comprising the path from the mapped tile to the destination tile comprises a means for determining a shortest Manhattan distance between the mapped tile and the destination tile.

25. The CGRA configuration circuit of claim 22, further comprising a means for outputting the function control configuration and the switch control configuration for each mapped tile to a CGRA configuration buffer.

26. The CGRA configuration circuit of claim 22, further comprising a means for decoding each dataflow instruction and generating the function control configuration and the switch control configuration for each mapped tile using a distributed decoder unit of a plurality of distributed decoder units corresponding to the mapped tile.

27. The CGRA configuration circuit of claim 22, further comprising a means for selecting, at runtime, one of the CGRA and the block-based dataflow computer processor core to execute the dataflow instruction block.

28. The CGRA configuration circuit of claim 27, further comprising a means for determining, at runtime, whether generation of the function control configuration and the switch control configuration for each mapped tile was successful;
wherein the means for selecting, at runtime, one of the CGRA and the block-based dataflow computer processor core to execute the dataflow instruction block comprises:
a means for selecting the CGRA to execute the dataflow instruction block responsive to determining that the generation of the function control configuration and the switch control configuration for each mapped tile was successful; and
a means for selecting the block-based dataflow computer processor core to execute the dataflow instruction block responsive to determining that the generation of the function control configuration and the switch control configuration for each mapped tile was not successful.

29. The CGRA configuration circuit of claim 27, further comprising a means for determining, at runtime, whether the CGRA provides a required resource;
wherein the means for selecting, at runtime, one of the CGRA and the block-based dataflow computer processor core to execute the dataflow instruction block comprises:
a means for selecting the CGRA to execute the dataflow instruction block responsive to determining that the CGRA provides the required resource; and
a means for selecting the block-based dataflow computer processor core to execute the dataflow instruction block responsive to determining that the CGRA does not provide the required resource.
